(19) United States
(12) Patent Application Publication
(10) Pub. No.: US 2026/0093269 A1
(43) Pub. Date: Apr. 2, 2026

(54) AIRCRAFT LANDING SITE DETERMINATION FOR AUTOMATED EMERGENCY LANDING CONTROL

(71) Applicant: The Boeing Company, Arlington, VA (US)

(72) Inventors: Dragos M. Popescu, Phoenix, AZ (US); Julie A. Pruitt, Rockwall, TX (US); William Robert Bankwitz, Phoenix, AZ (US)

(21) Appl. No.: 18/889,181

(22) Filed: Sep. 18, 2024

(51) Int. Cl. G05D 1/654; B64C 13/18; B64C 27/02; B64C 27/04; B64D 45/08; G05D 1/242; G05D 1/245; G05D 1/246; G05D 1/248; G05D 109/25; G05D 111/10

(52) U.S. Cl. CPC G05D 1/6546; B64C 13/18; B64C 27/025; B64C 27/04; B64D 45/08; G05D 1/242; G05D 1/245; G05D 1/246; G05D 1/248; G05D 2109/25; G05D 2111/14

(57) ABSTRACT

A vertical-takeoff-and-landing (VTOL) aircraft includes a plurality of navigation sensors and processing circuitry configured to implement a navigation system. The plurality of navigation sensors is configured to output navigation sensor data. The navigation system is configured to receive road map data, aviation map data, and navigation sensor data and execute an automated emergency landing control module. The automated emergency landing control module is configured to identify a plurality of candidate landing sites using the road map data, the aviation map data, and the navigation sensor data, and select a target landing site from among the plurality of candidate landing sites. Upon detection of an emergency condition, the automated emergency landing control module outputs the target landing site.

### FIELD

The present disclosure relates generally to a system for detecting hazards and selecting a safe landing zone for a vertical-takeoff-and-landing (VTOL) aircraft during automated emergency landing control.

### BACKGROUND

When a VTOL aircraft, such as a helicopter, experiences engine failure during a flight, a series of maneuvers must be performed to achieve a state of autorotation and control the descent of the aircraft. Recent advancements have been made in the area of automated flight control systems that initiate automated autorotation when an emergency condition is detected. However, while the descent of the aircraft may be controlled by maintaining rotor speed during autorotation, challenges exist in determining safe landing sites, selecting a target landing site, and guiding the aircraft to the target landing site during automated emergency landing control.

### SUMMARY

According to an example of the present disclosure, a vertical-takeoff-and-landing (VTOL) aircraft is provided. The VTOL aircraft includes a plurality of navigation sensors and processing circuitry that is configured to implement a navigation system. The plurality of navigation sensors is configured to output navigation sensor data. The navigation system is configured to receive road map data, aviation map data, and navigation sensor data and execute an automated emergency landing control module. The automated emergency landing control module is configured to identify a plurality of candidate landing sites using the road map data, the aviation map data, and the navigation sensor data, and select a target landing site from among the plurality of candidate landing sites. Upon detection of an emergency condition, the automated emergency landing control module outputs the target landing site.

According to another example of the present disclosure, a method for determining a landing site for a vertical-takeoff-and-landing (VTOL) aircraft under automated emergency landing control is provided. The method includes receiving road map data, aviation map data, and navigation sensor data; executing an automated emergency landing control module; identifying a plurality of candidate landing sites using the road map data, the aviation map data, and the navigation sensor data; selecting a target landing site from among the plurality of candidate landing sites; and outputting the target landing site upon detection of an emergency condition.

According to another example of the present disclosure, navigation system for a vertical-takeoff-and-landing (VTOL) aircraft is provided. The navigation system comprises processing circuitry that is configured to receive road map data, aviation map data, and navigation sensor data. The navigation sensor data is received from a plurality of navigation sensors, including a light detection and ranging (LiDAR) system. The processing circuitry is further configured to execute an automated emergency landing control module to identify a plurality of candidate landing sites using the road map data, the aviation map data, and the navigation sensor data; select a target landing site from among the plurality of candidate landing sites; and output the target landing site upon detection of an emergency condition. The plurality of candidate landing sites are selected based on viability of successful navigation to each candidate landing site under the emergency condition using an autorotation mode of flight, and the target landing site is calibrated during an approach phase based on landing site obstacle detection using the LiDAR system.

### BRIEF DESCRIPTION OF THE DRAWINGS

FIG. 1 is an example VTOL aircraft navigating to a target landing site in an urban area in an automated emergency landing control mode, according to the present disclosure.

FIG. 2 is a schematic diagram of an example VTOL aircraft having a navigation system, a guidance system, and a flight control system, according to the present disclosure.

FIG. 3 is a schematic diagram of an example automated emergency landing control module, according to the present disclosure.

FIG. 4 is an example decision tree for executing an automated emergency landing control mode, according to the present disclosure.

FIG. 5 is a flow chart of a method for determining a landing site for a VTOL aircraft under automated emergency landing control, according to an example implementation of the present disclosure.

FIG. 6 is an example computing system according to one implementation of the present disclosure.

### DETAILED DESCRIPTION

In view of the issues discussed above, systems and methods for determining a safe aircraft landing site for automated emergency landing control are disclosed herein. The systems can be used, for example, to facilitate the identification of candidate landing sites throughout the entirety of a flight. The systems and methods have the potential to allow a vertical-takeoff-and-landing (VTOL) aircraft to perform an automated autorotation to a selected target landing site with or without the assistance of a pilot.

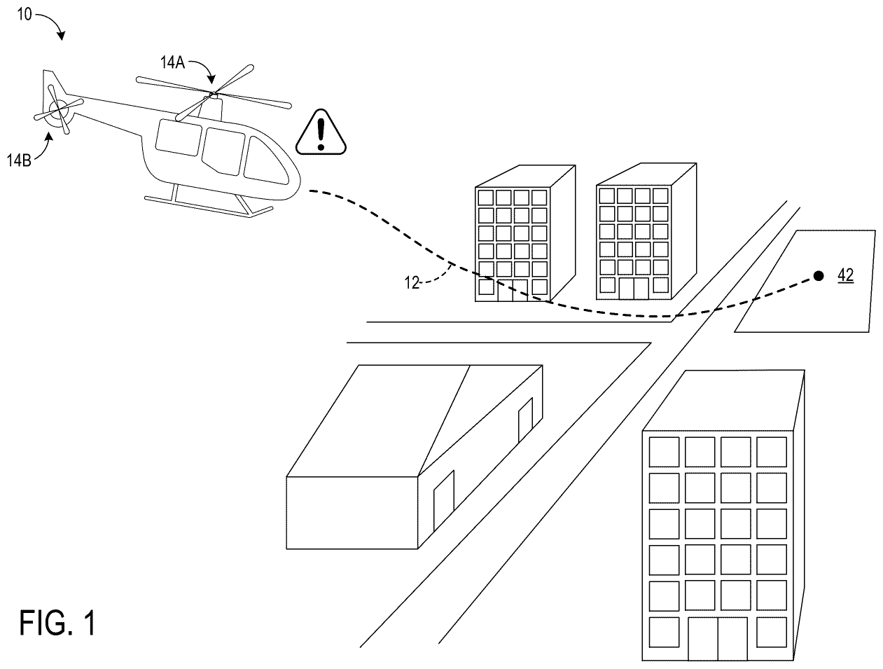

FIG. 1 shows a schematic view of an example VTOL aircraft 10 navigating to a target landing site 42 in an urban area in an automated emergency landing control mode. As the present disclosure is directed to determining and navigating to a target landing site during autorotation, the VTOL aircraft 10 is at least partially powered by rotors, such as a traditional helicopter, a gyrodyne, a tiltrotor, an electrically propelled VTOL (eVTOL), or an unmanned aerial vehicle (UAV). Thus, the aircraft may have a pilot, or it may be an autonomous or remotely piloted aircraft. Additionally or alternatively, the aircraft may be an urban air motility (UAM) passenger aircraft. As discussed in detail below, road map data, aviation map data, and navigation sensor data detect hazards and obstacles and provide navigation state data. In the example shown in FIG. 1 and as described in detail below, the VTOL aircraft 10 is equipped with a navigation system that detects obstacles and hazards, such as buildings in the urban area. A flight control system may be used to control surface subsystems 14 of the VTOL aircraft 10, such as a main rotor 14A and a tail rotor 14B. The dashed line indicates an emergency route 12 of the VTOL aircraft 10 as it is guided toward the target landing site 42.

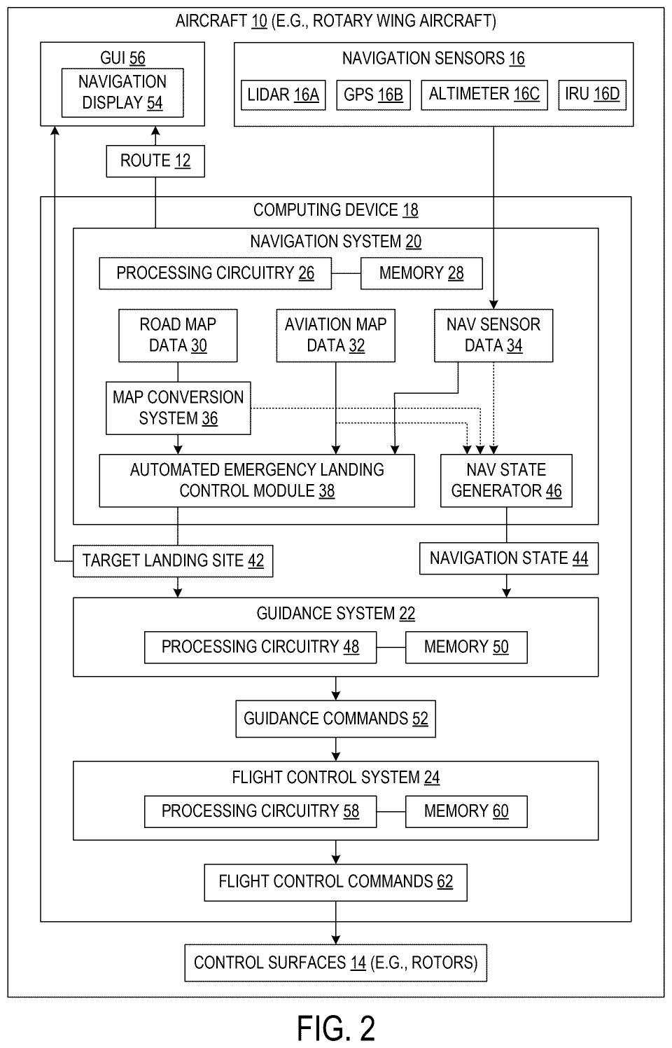

Turning to FIG. 2, a schematic diagram of an example VTOL aircraft 10 is shown. The VTOL aircraft 10 is equipped with a plurality of navigation sensors 16, including a light detection and ranging (LiDAR) system 16A configured to detect obstacles at candidate landing sites, a global positioning system (GPS) sensor 16B configured to detect latitude and longitude of the VTOL aircraft 10, an altimeter 16C configured to detect an altitude of the VTOL aircraft 10, and an inertial reference unit 16D configured to detect an attitude the VTOL aircraft 10. The VTOL aircraft 10 further includes a computing device 18, which may be implemented as an onboard computing device that includes a navigation system 20, a guidance system 22, and a flight control system 24.

The navigation system 20 is implemented by processing circuitry 26 and associated memory 28, and is configured to receive road map data 30, aviation map data 32, and navigation sensor data 34. The aviation map data 32 may be received from one or more aviation map databases or a distributed data storage system, for example, and the navigation sensor data 34 is output by the plurality of navigation sensors 16.

The road map data 30 may be open source road map data received from one or more road map applications, and may include the transportation infrastructure of a region, as well as the locations (i.e., coordinates) of buildings, landmarks, points of interest, bodies of water, and other features of the terrestrial environment. The navigation system 20 includes a road map conversion system 36 configured to convert the road map data 30 into a format compatible with the aviation map data 32. The map conversion system 36 extracts the road map data 30 onto the aviation map data 32 to provide information about the environment that is not available through aviation maps.

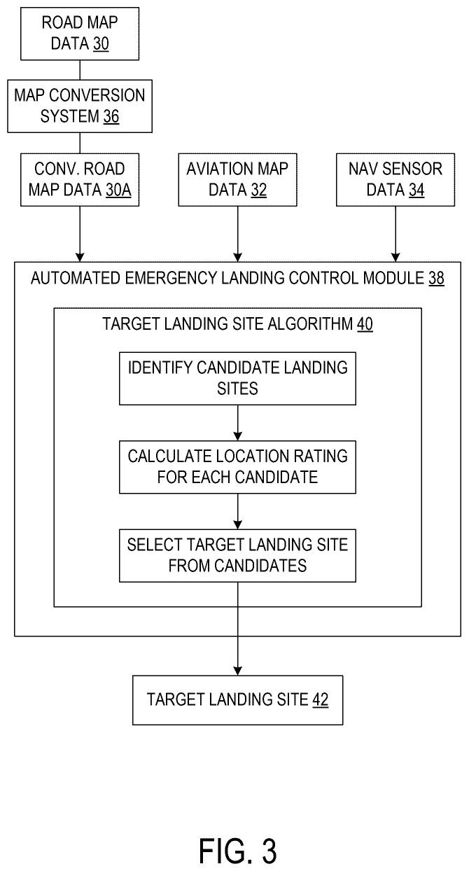

The navigation system 20 may execute an automated emergency landing control module 38 throughout the flight. Turning to FIG. 3, an example of the automated emergency landing control module 38 is shown. The automated emergency landing control module 38 receives the converted road map data 30A, the aviation map data 32, and the navigation sensor data 34. A target landing site algorithm 40 included in the automated emergency landing control module 38 uses the received data to identify a plurality of candidate landing sites that may be used in case of an emergency. The plurality of candidate landing sites are viable, safe landing sites that are determined by the navigation system 20 to be reachable by the VTOL aircraft 10 under controlled flight conditions implemented by the guidance system 22 and the flight control system 24 of the VTOL aircraft 10 during the emergency condition, based on the road map data 30, the aviation map data 32, and the navigation sensor data 34.

For each candidate landing site, the target landing site algorithm 40 calculates a location rating. The location rating may be calculated based at least in part on altitude, attitude, position, velocity, and acceleration of the VTOL aircraft 10 detected by the navigation sensors 16, and on geography, hazards, location coordinates, obstacles, terrain, and weather conditions of the ground environment indicated in the road map data 30 and aviation map data 32. The current and predicted kinetic energy of the VTOL aircraft 10, as well as the current and predicted potential energy of the VTOL aircraft 10, may be calculated to determine an estimated distance that the VTOL aircraft 10 can safely reach with respect to the above-mentioned factors. Additionally, the current and predicted rotational energy of the rotors 14 may be calculated and included in the estimated distance. The road map data 30, aviation map data 32, and navigation sensor data 34 are received by the automated emergency landing control module 38 and used by the target landing site algorithm 40 to calculate location ratings for each candidate landing site.

Once the location rating for each candidate landing site has been calculated, a target landing site 42 is selected from among the candidates. The target landing site 42 is a candidate landing site that is calculated to have a highest location rating for a successful landing with respect to respective location ratings of each of the plurality of candidate landing sites, based on the road map data 30, the aviation map data 32, and the navigation sensor data 34. As shown in FIG. 2, the target landing site 42 is output to the guidance system 22 upon detection of an emergency condition.

The target landing site 42 may be calibrated during an approach phase of the VTOL aircraft 10 based at least in part on the obstacle detected conducted by the LiDAR system 16A. The LiDAR system 16A is configured to capture visual data within a proximity to the VTOL aircraft 10. As such, the road map data 30, aviation map data 32, and navigation sensor data 34 are used to determine the target landing site 42, and the visual data collected by the LiDAR system 16A is used to calibrate, i.e., fine-tune, the target landing site 42 to avoid landing site obstacles as the VTOL aircraft 10 approaches the target landing site 42.

The road map data 30 is essential when making determinations with regard to safe landing, as it may provide potential safe landing sites, such as parking lots, open fields, nearby helipads, or other open areas without an excess of hazards such as buildings, power lines, trees, and other obstacles. Conversely, the road map data 30 may help eliminate landing sites that are not viable. Additionally, the LiDAR system 16A is relied upon for visual detection of obstacles, such as trees, power lines, tall structures, and the like, that will not be included in the road map data 30 and the aviation map data 32, or detected by other navigation sensors 16B, 16C, 16D. In such conditions, the LiDAR system 16A is an important tool in landing site calibration, as data from the LiDAR system 16A can be used to fine-tune the target landing site 42 by providing visualization of obstacles and hazards that need to be avoided.

In addition to selecting a target landing site 42, the navigation system 20 is further configured to generate a navigation state 44 of the VTOL aircraft 10 via a navigation state generator 46, based at least on the road map data 30, the aviation map data, 32 and the navigation sensor data 34. The navigation state 44 of the VTOL aircraft 10 indicates whether the VTOL aircraft 10 is experiencing normal flight operation conditions or if an emergency condition exists.

As illustrated in FIG. 2, the target landing site 42 and the navigation state 44 of the VTOL aircraft 10 as determined by the navigation system 20 are output to the guidance system 22. The guidance system 22 may be implemented by processing circuitry 48 and associated memory 50, and configured to determine that the emergency condition exists, based on the navigation state 44 of the VTOL aircraft 10. In response to determining that the emergency condition exists, the guidance system 22 executes an automated emergency landing control mode, which is an autorotation mode of the VTOL aircraft 10.

During normal flight conditions, the guidance system 22 may ignore the target landing site 42 output by the navigation system 20. However, in the emergency landing control mode, the guidance system 22 is configured to receive the target landing site 42 and generate guidance commands 52 to guide the VTOL aircraft 10 to land at the target landing site 42 under the emergency conditions. The generated guidance commands 52 are output to the flight control system 24. Additionally, the outputted target landing site 42 and the emergency route 12 of the VTOL aircraft 10 may be output to a navigation display 54 in a graphical user interface (GUI) 56 to enable a pilot to engage in manual or autopilot assisted flight control to the target landing site 42. The target landing site 42 and the emergency route 12 may be displayed in the context of a road map and/or an aviation map, for example.

The flight control system 24 may be implemented by processing circuitry 58 and associated memory 60. The flight control system 24 is configured to receive the guidance commands 52 output from the guidance system 22, generate flight control commands 62 based upon the guidance commands 52, and output the flight control commands 62. The flight control commands 62 determine how the control surface subsystems 14 of the VTOL aircraft 10 will be adjusted to programmatically control the VTOL aircraft 10 to land at the target landing site 42.

The immediacy of the transition in guidance commands 52 allows the VTOL aircraft 10 to be guided to the target landing site 42 as soon as the autorotation mode is initiated. The guidance system 22 continuously generates guidance commands 52 for the flight control system 24 to follow until the VTOL aircraft 10 safely lands.

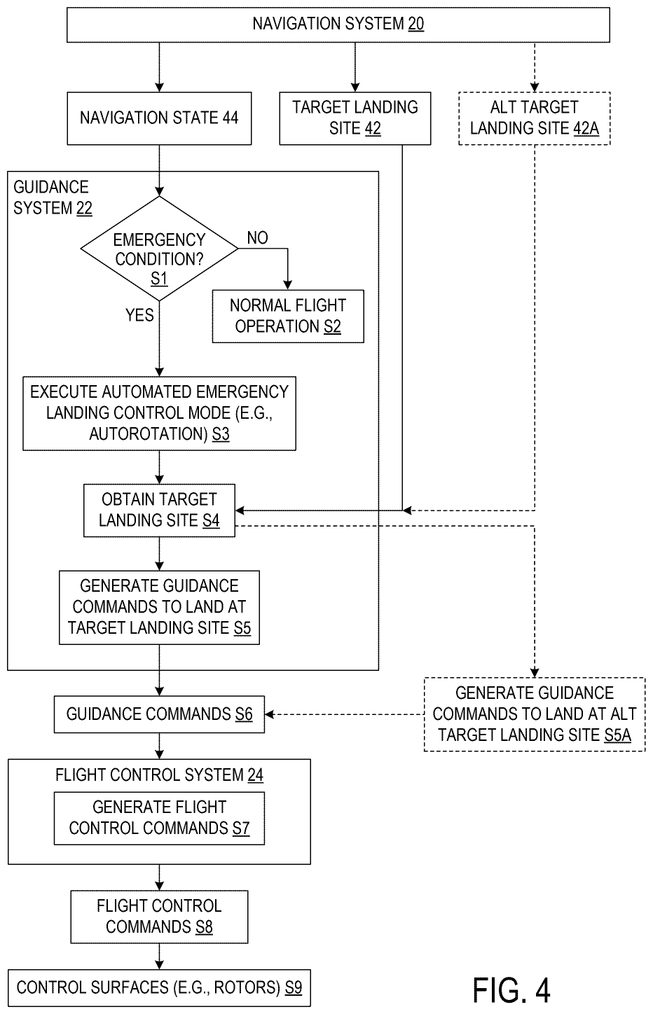

Turning to FIG. 4, an example decision tree for executing an automated emergency landing control mode is shown. As described in detail above, the navigation system 20 is configured to output the navigation state 44 of the VTOL aircraft 10 and the target landing site 42 to the guidance system 22. At step S1, the guidance system 22 may determine if the VTOL aircraft 10 is experiencing an emergency condition. If the outcome is NO, the decision moves to step S2 and continues normal flight operation. If the outcome is YES, the decision moves to step S3, and the automated emergency landing control mode is executed. At step S4 of the decision, the guidance system 22 obtains the target landing site 42 from the navigation system 20, and generates guidance commands 52 to land at the target landing site 42 at step S5 At step S6, the guidance system 22 outputs the generated guidance commands 52 to the flight control system 24. The flight control system 24 converts the guidance commands 52 to generate flight control commands at step S7 of the decision. At step S8, the flight control commands 62 are output, and the surface subsystems 14 (e.g., rotors 14A, 14B) of the VTOL aircraft 10 are controlled according to the flight control commands 62 at step S9 to guide the VTOL aircraft 10 to the target landing site 42.

As the VTOL aircraft 10 approaches the target landing site 42 during the automated emergency landing control mode, the navigation system 20 is further configured to receive real time updates to the road map data 30, the aviation map data 32, and the navigation sensor data 34. The refinement of this data allows adjustments to be made to the target landing site location as the VTOL aircraft 10 approaches it, or a complete change of the target landing site location may occur if a candidate landing site having a higher location rating than the target landing site 42 is identified and selected. To this end, based on the real time updates, when an alternate target landing site 42A having a higher location rating than the target landing site 42 is identified or when the selected target site 42 is determined to be no longer viable, the VTOL aircraft 10 will generate guidance commands 52 to programmatically control the VTOL aircraft 10 to land at the alternate target landing site 42A, as shown at step S5 and indicated in dashed line in the decision tree in FIG. 4.

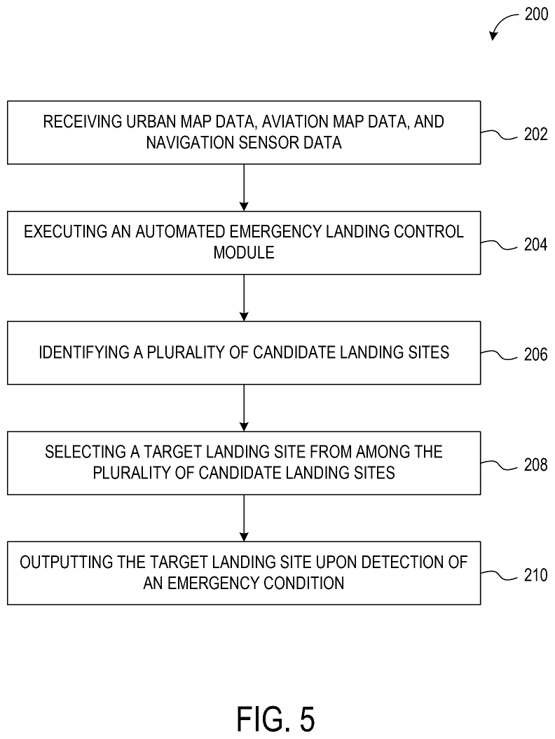

FIG. 5 is a flow chart for a method 200 for determining a landing site for a VTOL aircraft under automated emergency landing control. The method 200 may be implemented by the hardware and software of the VTOL aircraft 10 described above, or by other suitable hardware and software. At step 202, the method 200 may include receiving road map data, aviation map data, and navigation sensor data. As described above the aviation map data may be received from one or more aviation map databases or a distributed data storage system, and the road map data 30 may be open source road map data received from one or more road map applications. The navigation sensor data is output from a plurality of navigation sensors, including a light detection and ranging (LiDAR) system configured to detect obstacles at each of the plurality of candidate landing sites, a global positioning system (GPS) sensor configured to detect latitude and longitude of the VTOL aircraft, an altimeter configured to detect an altitude of the VTOL aircraft, and/or an inertial reference unit configured to detect an attitude the VTOL aircraft.

Proceeding from step 202 to step 204, the method 200 may further include executing an automated emergency landing control module. The automated emergency landing control module may control the VTOL aircraft to enter an autorotation mode when the engine loses power, thereby enabling the VTOL aircraft to descend to a landing site.

Advancing from step 204 to step 206, the method 200 may further include identifying a plurality of candidate landing sites using the road map data, the aviation map data, and the navigation sensor data. The plurality of candidate landing sites are viable, safe landing sites that are determined to be reachable by the VTOL aircraft under controlled flight conditions during the autorotation mode.

Continuing from step 206 to step 208, the method 200 may further include selecting a target landing site from among the plurality of candidate landing sites. As described above, the target landing site is a candidate landing site that is calculated to have a highest location rating for a successful landing with respect to respective location ratings of each of the plurality of candidate landing sites, based at least in part on: altitude, attitude, position, velocity, and acceleration of the VTOL aircraft detected by the navigation sensors; geography, hazards, location coordinates, obstacles, terrain, and weather conditions of the ground environment indicated in the road map data and the aviation map data; and the current and predicted kinetic and potential energies of the VTOL aircraft. The target landing site may be calibrated during an approach phase based on obstacle detection conducted by the LiDAR system.

Proceeding from step 208 to step 210, the method 200 may further include outputting the target landing site upon detection of an emergency condition. As described above, a navigation state of the VTOL aircraft is output in addition to the target landing site. The output target landing site and the emergency route of the VTOL aircraft may be output to a navigation display and displayed in the context of a road map and/or an aviation map.

At a guidance system, the method 200 may include determining, based on the navigation state of the VTOL aircraft, that the emergency condition exists; in response to determining that the emergency condition exists, executing an automated emergency landing control mode; receiving the target landing site output from the navigation system; and generating guidance commands to guide the VTOL aircraft to land at the target landing site under the emergency condition; and outputting the generated guidance commands.

At a flight control system, the method 200 may include receiving the guidance commands outputted from the guidance system; generating flight control commands based upon the guidance commands; and outputting the flight control commands to control surface subsystems of the VTOL aircraft to programmatically control the VTOL aircraft to land at the target landing site.

During the automated emergency landing control mode, the method 200 may include receiving real time updates to the road map data, the aviation map data, and the navigation sensor data, and based on the real time updates, when an alternate target landing site with a higher location rating than the target landing site is identified or when the selected target site is determined to be no longer viable, programmatically controlling the VTOL aircraft to land at the alternate target landing site.

In some embodiments, the methods and processes described herein may be tied to a computing system of one or more computing devices. In particular, such methods and processes may be implemented as a computer-application program or service, an application-programming interface (API), a library, and/or other computer-program products.

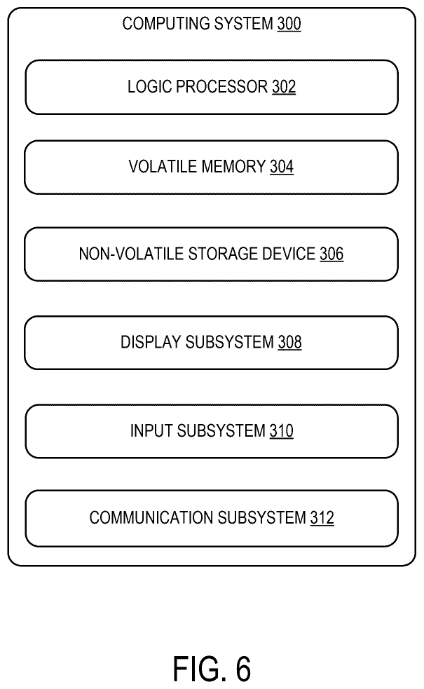

FIG. 6 schematically shows a non-limiting embodiment of a computing system 300 that can enact one or more of the methods and processes described above. Computing system 300 is shown in simplified form. Computing system 300 may embody the computing device 18 described above and illustrated in FIG. 2. Components of computing system 300 may be included in one or more personal computers, server computers, tablet computers, home-entertainment computers, network computing devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions to perform a task, implement a data type, transform the state of one or more components, achieve a technical effect, or otherwise arrive at a desired result.

The logic processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. These physical logic processors of the two or more separate devices will be understood to be collectively encompassed by processing circuitry 302.

Non-volatile storage device 306 includes one or more physical devices configured to hold instructions executable by the processing circuitry to implement the methods and processes described herein, and may include physical devices that are removable and/or built-in. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

Further, the disclosure comprises configurations according to the following examples.

Example 1. A vertical-takeoff-and-landing (VTOL) aircraft comprising: a plurality of navigation sensors configured to output navigation sensor data; and processing circuitry configured to implement a navigation system, wherein the navigation system is configured to: receive road map data, aviation map data, and navigation sensor data; execute an automated emergency landing control module configured to identify a plurality of candidate landing sites using the road map data, the aviation map data, and the navigation sensor data, and select a target landing site from among the plurality of candidate landing sites; and output the target landing site upon detection of an emergency condition.

Example 2. The VTOL aircraft of example 1, wherein the output target landing site is output to a graphical user interface of the navigation system to enable a pilot to engage in manual or autopilot assisted flight control to the target landing site.

Example 3. The VTOL aircraft of examples 1 or 2, wherein the navigation system is further configured to generate a navigation state of the VTOL aircraft based at least on the road map data, the aviation map data, and the navigation sensor data, and the processing circuitry is further configured to implement a guidance system, wherein the guidance system is configured to: determine, based on the navigation state of the VTOL aircraft, that the emergency condition exists, and in response to determining that the emergency condition exists, execute an automated emergency landing control mode, in which the guidance system is configured to: receive the target landing site output from the navigation system; generate guidance commands to guide the VTOL aircraft to land at the target landing site under the emergency condition; and output the generated guidance commands.

Example 4. The VTOL aircraft of example 3, wherein the processing circuitry is further configured to implement a flight control system, wherein the flight control system is configured to: receive the guidance commands outputted from the guidance system; generate flight control commands based upon the guidance commands; and output the flight control commands to control surface subsystems of the VTOL aircraft to programmatically control the VTOL aircraft to land at the target landing site.

Example 5. The VTOL aircraft of example 4, wherein the surface subsystems include at least one rotor of the VTOL aircraft.

Example 6. The VTOL aircraft of example 5, wherein the automated emergency landing control mode is an autorotation mode of the VTOL aircraft.

Example 7. The VTOL aircraft of any one of examples 1-6, wherein the navigation system includes a road map conversion system configured to convert the road map data into a format compatible with the aviation map data.

Example 8. The VTOL aircraft of any one of examples 1-7, wherein the plurality of candidate landing sites are viable landing sites that are determined by the navigation system to be reachable by the VTOL aircraft under controlled flight conditions implemented by a guidance system and a flight control system of the VTOL aircraft during the emergency condition, based on the road map data, the aviation map data, and the navigation sensor data.

Example 9. The VTOL aircraft of any one of examples 1-8, wherein the target landing site is a candidate landing site that is calculated to have a highest location rating for a successful landing with respect to respective location ratings of each of the plurality of candidate landing sites, based on the road map data, the aviation map data, and the navigation sensor data.

Example 10. The VTOL aircraft of any one of examples 1-9, wherein the plurality of navigation sensors includes a light detection and ranging (LiDAR) system configured to detect landing site obstacles at the target landing site, and the target landing site is calibrated during an approach phase of the VTOL aircraft based on the obstacle detection conducted by the LiDAR system.

Example 11. The VTOL aircraft of any one of examples 1-10, wherein the plurality of navigation sensors includes a global positioning system (GPS) sensor configured to detect latitude and longitude of the VTOL aircraft, an altimeter configured to detect an altitude of the VTOL aircraft, and/or an inertial reference unit configured to detect an attitude the VTOL aircraft

Example 12. The VTOL aircraft of example 9, wherein the location ratings are calculated based at least in part on acceleration, altitude, attitude, position, and velocity of the VTOL aircraft detected by the navigation sensors.

Example 13. The VTOL aircraft of example 9, wherein the location ratings are calculated based at least in part on geography, hazards, location coordinates, obstacles, terrain, and weather conditions of the ground environment indicated in the road map data and aviation map data.

Example 14. The VTOL aircraft of example 3, wherein during the automated emergency landing control mode, the processing circuitry is further configured to receive real time updates to the road map data, the aviation map data, and the navigation sensor data, and based on the real time updates, when an alternate target landing site having a higher location rating than the target landing site is identified or when the selected target site is determined to be no longer viable, the VTOL aircraft will be programmatically controlled to land at the alternate target landing site.

Example 15. A method for determining a landing site for a vertical-takeoff-and-landing (VTOL) aircraft under automated emergency landing control, the method comprising: receiving road map data, aviation map data, and navigation sensor data; executing an automated emergency landing control module; identifying a plurality of candidate landing sites using the road map data, the aviation map data, and the navigation sensor data; selecting a target landing site from among the plurality of candidate landing sites; and outputting the target landing site upon detection of an emergency condition.

Example 16. The method of example 15, the method further comprising: at a guidance system: determining, based on the navigation state of the VTOL aircraft, that the emergency condition exists; in response to determining that the emergency condition exists, executing an automated emergency landing control mode; receiving the target landing site output from the navigation system; generating guidance commands to guide the VTOL aircraft to land at the target landing site under the emergency condition; and outputting the generated guidance commands, and, at a flight control system: receiving the guidance commands outputted from the guidance system; generating flight control commands based upon the guidance commands; and outputting the flight control commands to control surface subsystems of the VTOL aircraft to programmatically control the VTOL aircraft to land at the target landing site.

Example 17. The method of example 16, wherein the surface subsystems include at least one rotor of the VTOL aircraft, and the automated emergency landing control mode is an autorotation mode of the VTOL aircraft.

Example 18. The method of example 16 or 17, the method further comprising: including in the plurality of navigation sensors a light detection and ranging (LiDAR) system configured to detect obstacles at each of the plurality of candidate landing sites, a global positioning system (GPS) sensor configured to detect latitude and longitude of the VTOL aircraft, an altimeter configured to detect an altitude of the VTOL aircraft, and/or an inertial reference unit configured to detect an attitude the VTOL aircraft, and calibrating the target landing site during an approach phase of the VTOL aircraft based on the obstacle detection conducted by the LiDAR system.

Example 19. The method of any one or examples 16-18, the method further comprising: selecting the target landing site to be a candidate landing site that is calculated to have a highest location rating for a successful landing with respect to respective location ratings of each of the plurality of candidate landing sites, based at least in part on: acceleration, altitude, attitude, position, and velocity of the VTOL aircraft detected by the navigation sensors, and geography, hazards, location coordinates, obstacles, terrain, and weather conditions of the ground environment indicated in the road map data and the aviation map data; during the automated emergency landing control mode, receiving real time updates to the road map data, the aviation map data, and the navigation sensor data; and based on the real time updates, when an alternate target landing site with a higher location rating than the target landing site is identified or when the selected target site is determined to be no longer viable, programmatically controlling the VTOL aircraft to land at the alternate target landing site.

Example 20. A navigation system for vertical-takeoff-and-landing (VTOL) aircraft, the navigation system comprising: processing circuitry configured to: receive road map data, aviation map data, and navigation sensor data, the navigation sensor data being received from a plurality of navigation sensors including a light detection and ranging (LiDAR) system; execute an automated emergency landing control module to identify a plurality of candidate landing sites using the road map data, the aviation map data, and the navigation sensor data; select a target landing site from among the plurality of candidate landing sites; and output the target landing site upon detection of an emergency condition, wherein the plurality of candidate landing sites are selected based on viability of successful navigation to each candidate landing site under the emergency condition using an autorotation mode of flight, and the target landing site is calibrated during an approach phase based on landing site obstacle detection using the LiDAR system.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A vertical-takeoff-and-landing (VTOL) aircraft comprising:
a plurality of navigation sensors configured to output navigation sensor data; and
processing circuitry configured to implement a navigation system, wherein
the navigation system is configured to:
receive road map data, aviation map data, and navigation sensor data;
execute an automated emergency landing control module configured to identify a plurality of candidate landing sites using the road map data, the aviation map data, and the navigation sensor data, and select a target landing site from among the plurality of candidate landing sites; and
output the target landing site upon detection of an emergency condition.

2. The VTOL aircraft of claim 1, wherein
the target landing site is output to a graphical user interface of the navigation system to enable a pilot to engage in manual or autopilot assisted flight control to the target landing site.

3. The VTOL aircraft of claim 1, wherein
the navigation system is further configured to generate a navigation state of the VTOL aircraft based at least on the road map data, the aviation map data, and the navigation sensor data, and
the processing circuitry is further configured to implement a guidance system, wherein the guidance system is configured to:
determine, based on the navigation state of the VTOL aircraft, that the emergency condition exists, and
in response to determining that the emergency condition exists, execute an automated emergency landing control mode, in which the guidance system is configured to:
receive the target landing site output from the navigation system;
generate guidance commands to guide the VTOL aircraft to land at the target landing site under the emergency condition; and
output the generated guidance commands.

4. The VTOL aircraft of claim 3, wherein
the processing circuitry is further configured to implement a flight control system, wherein the flight control system is configured to:
receive the guidance commands output from the guidance system;
generate flight control commands based upon the guidance commands; and
output the flight control commands to control surface subsystems of the VTOL aircraft to programmatically control the VTOL aircraft to land at the target landing site.

5. The VTOL aircraft of claim 4, wherein
the surface subsystems include at least one rotor of the VTOL aircraft.

6. The VTOL aircraft of claim 5, wherein
the automated emergency landing control mode is an autorotation mode of the VTOL aircraft.

7. The VTOL aircraft of claim 1, wherein
the navigation system includes a road map conversion system configured to convert the road map data into a format compatible with the aviation map data.

8. The VTOL aircraft of claim 1, wherein
the plurality of candidate landing sites are viable landing sites that are determined by the navigation system to be reachable by the VTOL aircraft under controlled flight conditions implemented by a guidance system and a flight control system of the VTOL aircraft during the emergency condition, based on the road map data, the aviation map data, and the navigation sensor data.

9. The VTOL aircraft of claim 1, wherein
the target landing site is a candidate landing site that is calculated to have a highest location rating for a successful landing with respect to respective location ratings of each of the plurality of candidate landing sites, based on the road map data, the aviation map data, and the navigation sensor data.

10. The VTOL aircraft of claim 1, wherein
the plurality of navigation sensors includes a light detection and ranging (LiDAR) system configured to detect landing site obstacles at the target landing site, and
the target landing site is calibrated during an approach phase of the VTOL aircraft based on the obstacle detection conducted by the LiDAR system.

11. The VTOL aircraft of claim 1, wherein
the plurality of navigation sensors includes a global positioning system (GPS) sensor configured to detect latitude and longitude of the VTOL aircraft, an altimeter configured to detect an altitude of the VTOL aircraft, and/or an inertial reference unit configured to detect an attitude the VTOL aircraft.

12. The VTOL aircraft of claim 9, wherein
the location ratings are calculated based at least in part on acceleration, altitude, attitude, position, and velocity of the VTOL aircraft detected by the navigation sensors.

13. The VTOL aircraft of claim 9, wherein
the location ratings are calculated based at least in part on geography, hazards, location coordinates, obstacles, terrain, and weather conditions of the ground environment indicated in the road map data and aviation map data.

14. The VTOL aircraft of claim 3, wherein
during the automated emergency landing control mode, the processing circuitry is further configured to receive real time updates to the road map data, the aviation map data, and the navigation sensor data, and
based on the real time updates, when an alternate target landing site having a higher location rating than the target landing site is identified or when the selected target site is determined to be no longer viable, the VTOL aircraft will be programmatically controlled to land at the alternate target landing site.

15. A method for determining a landing site for a vertical-takeoff-and-landing (VTOL) aircraft under automated emergency landing control, the method comprising:
receiving road map data, aviation map data, and navigation sensor data;
executing an automated emergency landing control module;
identifying a plurality of candidate landing sites using the road map data, the aviation map data, and the navigation sensor data;
selecting a target landing site from among the plurality of candidate landing sites; and
outputting the target landing site upon detection of an emergency condition.

16. The method of claim 15, the method further comprising:
at a guidance system:
determining, based on the navigation state of the VTOL aircraft, that the emergency condition exists;
in response to determining that the emergency condition exists, executing an automated emergency landing control mode;
receiving the target landing site output from the navigation system;
generating guidance commands to guide the VTOL aircraft to land at the target landing site under the emergency condition; and
outputting the generated guidance commands, and
at a flight control system:
receiving the guidance commands output from the guidance system;
generating flight control commands based upon the guidance commands; and
outputting the flight control commands to control surface subsystems of the VTOL aircraft to programmatically control the VTOL aircraft to land at the target landing site.

17. The method of claim 16, wherein
the surface subsystems include at least one rotor of the VTOL aircraft, and
the automated emergency landing control mode is an autorotation mode of the VTOL aircraft.

18. The method of claim 16, the method further comprising:
including in the plurality of navigation sensors a light detection and ranging (LiDAR) system configured to detect obstacles at each of the plurality of candidate landing sites, a global positioning system (GPS) sensor configured to detect latitude and longitude of the VTOL aircraft, an altimeter configured to detect an altitude of the VTOL aircraft, and/or an inertial reference unit configured to detect an attitude the VTOL aircraft, and
calibrating the target landing site during an approach phase of the VTOL aircraft based on the obstacle detection conducted by the LiDAR system.

19. The method of claim 16, the method further comprising:
selecting the target landing site to be a candidate landing site that is calculated to have a highest location rating for a successful landing with respect to respective location ratings of each of the plurality of candidate landing sites, based at least in part on:
acceleration, altitude, attitude, position, and velocity of the VTOL aircraft detected by the navigation sensors, and
geography, hazards, location coordinates, obstacles, terrain, and weather conditions of the ground environment indicated in the road map data and the aviation map data;
during the automated emergency landing control mode, receiving real time updates to the road map data, the aviation map data, and the navigation sensor data; and
based on the real time updates, when an alternate target landing site with a higher location rating than the target landing site is identified or when the selected target site is determined to be no longer viable, programmatically controlling the VTOL aircraft to land at the alternate target landing site.

20. A navigation system for vertical-takeoff-and-landing (VTOL) aircraft, the navigation system comprising:
processing circuitry configured to:
receive road map data, aviation map data, and navigation sensor data, the navigation sensor data being received from a plurality of navigation sensors including a light detection and ranging (LiDAR) system;
execute an automated emergency landing control module to identify a plurality of candidate landing sites using the road map data, the aviation map data, and the navigation sensor data;
select a target landing site from among the plurality of candidate landing sites; and
output the target landing site upon detection of an emergency condition, wherein
the plurality of candidate landing sites are selected based on viability of successful navigation to each candidate landing site under the emergency condition using an autorotation mode of flight, and
the target landing site is calibrated during an approach phase based on landing site obstacle detection using the LiDAR system.
